(19) United States
(12) Patent Application Publication
(10) Pub. No.: US 2025/0110964 A1
(43) Pub. Date: Apr. 3, 2025

(54) PROCESSING APPARATUS, PROCESSING METHOD AND PROGRAM

(71) Applicant: Nippon Telegraph and Telephone Corporation, Tokyo (JP)

(72) Inventors: Taizo YAMAMOTO, Musashino-shi, Tokyo (JP); Ai Tsunoda, Musashino-shi, Tokyo (JP); Takaaki MORIYA, Musashino-shi, Tokyo (JP); Manabu NISHIO, Musashino-shi, Tokyo (JP); Yu MIYOSHI, Musashino-shi, Tokyo (JP)

(21) Appl. No.: 18/729,092

(22) PCT Filed: Jan. 27, 2022
(86) PCT No.: PCT/JP2022/003133

§ 371 Date: Jul. 15, 2024

(51) Int. Cl. G06F 16/2458

(52) U.S. Cl. CPC G06F 16/2465; G06F 16/2477

(57) ABSTRACT

A processing device 1 includes: a calculation unit 22 that calculates deviation degrees of two items of time-series data among a plurality of items of time-series data through a plurality of respective analysis methods and calculates an evaluation value of variations in the deviation degrees calculated through the plurality of respective analysis methods for combinations of two items of time-series data among the plurality of items of time-series data; and an extraction unit 23 that extracts combinations of two items of time-series data for which the evaluation value satisfies a predetermined condition.

### TECHNICAL FIELD

The present invention relates to a processing device, a processing method, and a program.

### BACKGROUND ART

Recently, a large amount of data of mixed results can be obtained, and thus it is important to prepare an appropriate solution through appropriate analysis of data. At present, concepts of values are diversified, and meanings derived from certain data may become different meanings for other people.

In addition, data scientists analyze data from a plurality of viewpoints based on past work experience. Analysis of large amounts of data is a burden on the data scientists, and important data may be overlooked. In particular, an inexperienced data scientist may not be able to appropriately analyze a large amount of data and may not be able to identify data that is difficult to determine. Since it is not possible to appropriately analyze data that is difficult to determine, the data may not be used to contribute to preparation of an appropriate solution.

There is a technology that supports analysis of time-series data (Patent Literature 1). Patent Literature 1 discloses that an index value indicating a temporal change amount of each item of data within a predetermined period from a designated time point is calculated for each of a plurality of items of time-series data having a common data type, and the plurality of items of time-series data are displayed side by side in a sequential order depending on the calculated index value.

### CITATION LIST

### Patent Literature

Patent Literature 1: JP 2018-25891 A

### SUMMARY OF INVENTION

### Technical Problem

By extracting data that is difficult for data scientists to determine by computer processing, the data scientists can identify data that needs to be intensively analyzed from a large amount of data, and efficient analysis of the data scientists can be expected. However, Patent Literature 1 does not extract data that is difficult to determine.

The present invention has been made in view of the above circumstances, and an object of the present invention is to provide a technology capable of extracting data that is difficult for a data scientist to determine and supporting efficient analysis.

### Solution to Problem

A processing device of one aspect of the present invention includes: a calculation unit that calculates deviation degrees of two items of time-series data among a plurality of items of time-series data through a plurality of respective analysis methods and calculates an evaluation value of variations in the deviation degrees calculated through the plurality of respective analysis methods for combinations of two items of time-series data among the plurality of items of time-series data; an extraction unit that extracts combinations of two items of time-series data for which the evaluation value satisfies a predetermined condition; and an output unit that outputs the extracted combination.

A processing method of another aspect of the present invention includes: calculating, by a computer, deviation degrees of two items of time-series data among a plurality of items of time-series data through a plurality of respective analysis methods; calculating, by the computer, an evaluation value of variations in deviation degrees calculated through the plurality of respective analysis methods for combinations of two items of time-series data among the plurality of items of time-series data; extracting, by the computer, combinations of two items of time-series data for which the evaluation value satisfies a predetermined condition, and outputting, by the computer, the extracted combinations.

According to still another aspect of the present invention, there is provided a program for causing a computer to function as the aforementioned processing device.

### Advantageous Effects of Invention

According to the present invention, it is possible to provide a technology capable of extracting data that is difficult for a data scientist to determine and supporting efficient analysis.

### BRIEF DESCRIPTION OF DRAWINGS

FIG. 1 is a diagram illustrating a functional block of a processing device according to an embodiment of the present invention.

FIG. 2 is a diagram illustrating an example of a data structure and data of parameter data.

FIG. 3 is a diagram illustrating an example of a data structure and data of a time-series data group.

FIG. 4 is a diagram illustrating an example of a data structure and data of evaluation value data.

FIG. 5 is a diagram illustrating an example of a data structure and data of extraction data.

FIG. 6 is a diagram illustrating an example of an evaluation value.

FIG. 7 is a diagram illustrating an example of time-series data.

FIG. 8 is a flowchart of a processing device.

FIG. 9 is a flowchart of an update process.

FIG. 10 is a graph for evaluating an evaluation value calculated by the processing device according to the embodiment of the present invention.

FIG. 11 is a diagram illustrating a hardware configuration of a computer used in the processing device.

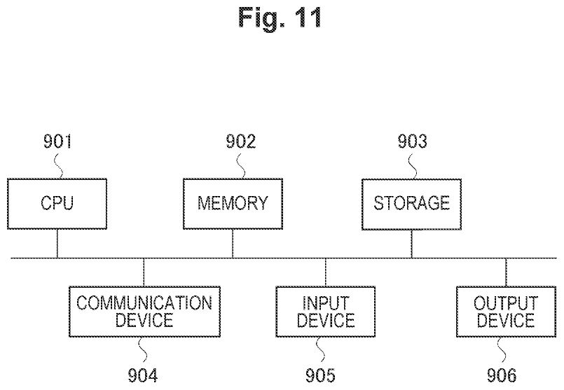

### DESCRIPTION OF EMBODIMENTS

Hereinafter, embodiments of the present invention will be described with reference to the drawings. In the drawings, the same reference signs are assigned to the same parts, and the description thereof is omitted.

### (Processing Device)

A processing device 1 according to an embodiment of the present invention extracts, as data that is difficult to determine, combinations of time-series data in which determination of similarity or dissimilarity between two items of time-series data varies or cannot be made depending on a person, among a plurality of items of time-series data. The processing device 1 can identify data that needs to be intensively analyzed from a large amount of data by extracting data that is difficult to determine, and thus the efficiency of analysis of the large amount of data is realized. The time-series data is data that identifies a change of a certain value for each time. An embodiment of the present invention will be described using time-series data of a consumer price index (price index by item) provided by Statistical Bureau, Ministry of Internal Affairs and Communications.

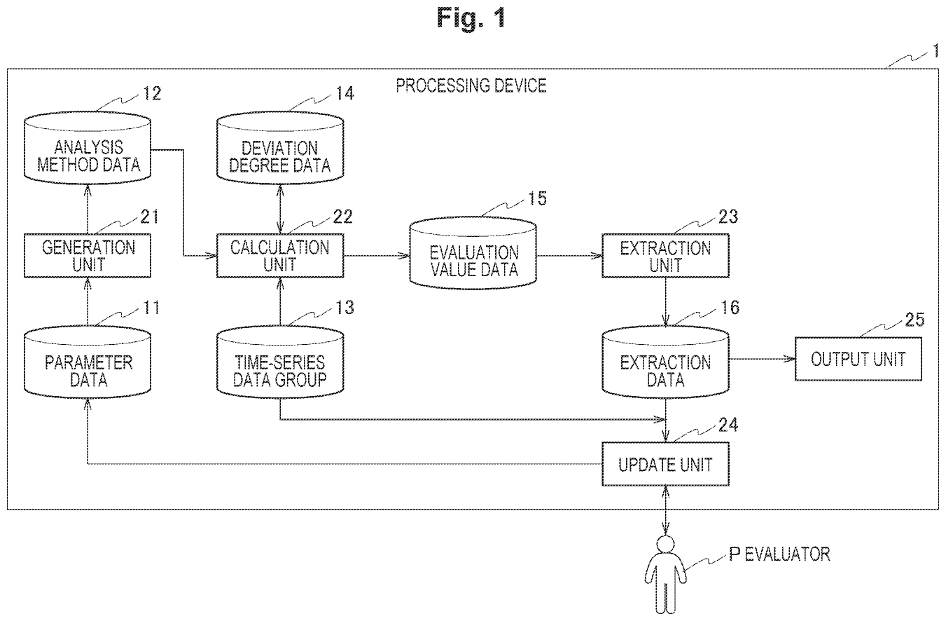

As illustrated in FIG. 1, the processing device 1 includes individual items of data of parameter data 11, analysis method data 12, a time-series data group 13, deviation degree data 14, evaluation value data 15, and extraction data 16, and individual functions of a generation unit 21, a calculation unit 22, an extraction unit 23, an update unit 24, and an output unit 25. The individual items of data are stored in a storage device such as a memory 902 or a storage 903. The individual functions are implemented by a CPU 901.

The parameter data 11 associates options selectable for individual parameters used in an analysis method for calculating a deviation degree of two items of time-series data. An identifier and options of a parameter identified by the parameter data 11 vary depending on the analysis methods.

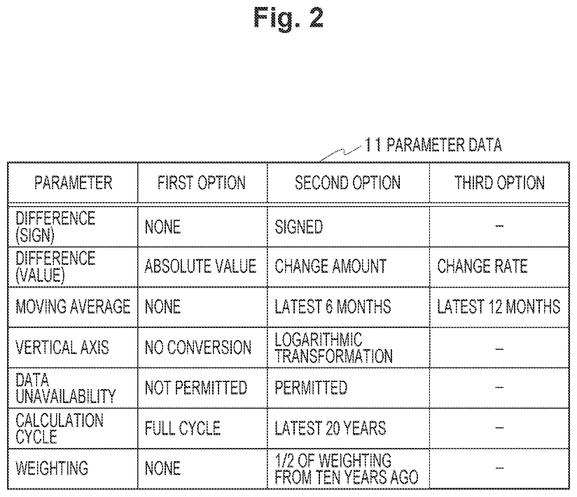

The parameter data 11 illustrated in FIG. 2 indicates options of individual parameters used in the analysis method for determining dissimilarity between the two items of time-series data. The parameter data 11 associates an identifier for identifying a parameter with a selectable option for each parameter. For example, a parameter “difference (value)” has three options of “absolute value”, “change amount”, and “change rate”. A parameter “vertical axis” has two options of “no conversion” and “logarithmic conversion”.

The analysis method data 12 is data that identifies a plurality of analysis methods for calculating the deviation degree of two items of time-series data. In the embodiment of the present invention, the plurality of analysis methods are identified by selecting any option for each parameter of the parameter data 11. The analysis method data 12 associates, for example, an identifier of an analysis method with a parameter used in the analysis method.

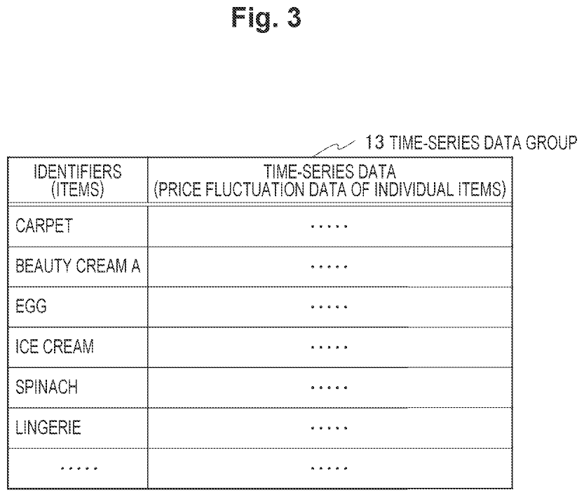

The time-series data group 13 is data of a population when the processing device 1 extracts data that is difficult to determine. As illustrated in FIG. 3, the time-series data group 13 includes a plurality of items of time-series data. In the embodiment of the present invention, the time-series data group 13 includes, regarding all of a plurality of items, price fluctuation data of the items.

The deviation degree data 14 is data obtained as a result of calculation of a deviation degree of two items of time-series data of the time-series data group 13 by the calculation unit 22 through each analysis method identified by the analysis method data 12. The deviation degree data 14 associates each identifier of the two items of time-series data for which the deviation degree is calculated, an identifier of the analysis method, and the calculated deviation degree.

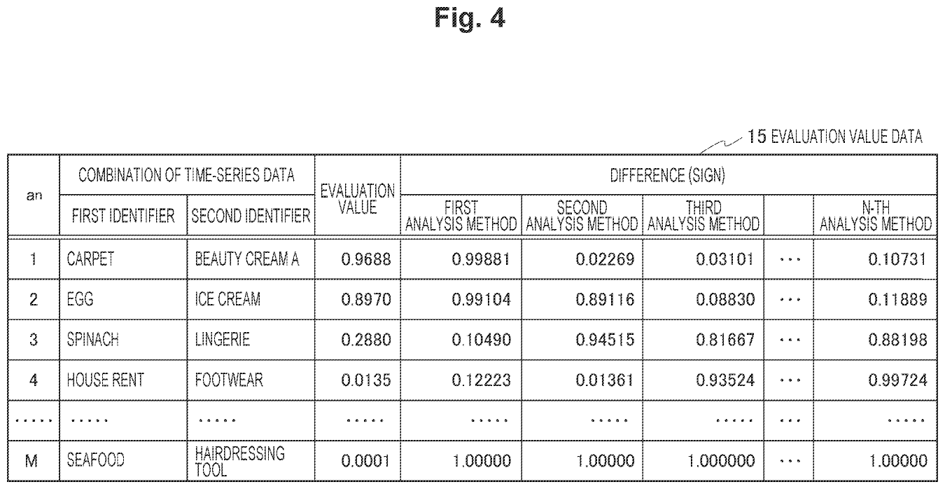

The evaluation value data 15 is data of evaluation values of variations in deviation degrees calculated through a plurality of analysis methods for the two items of time-series data. As illustrated in FIG. 4, the evaluation value data 15 associates identifiers of the two items of time-series data with evaluation values of the variations in the deviation degrees calculated for combinations of the items of data. In FIG. 4, the evaluation value data 15 also associates the deviation degrees in the individual analysis methods with respective identifiers of the two items of time-series data.

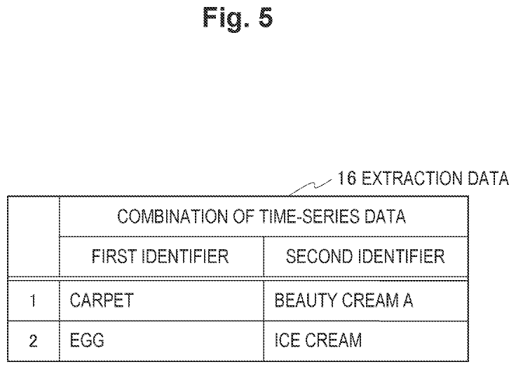

The extraction data 16 identifies a combination of two items of time-series data having a high evaluation value. As illustrated in FIG. 5, the extraction data 16 includes a combination of identifiers of two items of time-series data. In the example illustrated in FIG. 5, the extraction data includes two combinations. The extraction data 16 is generated from the evaluation value data 15 by the extraction unit 23.

The generation unit 21 generates, as a plurality of analysis methods, analysis methods in which any one of the options of the parameters for calculating the deviation degrees of the two items of time-series data is selected. The generation unit 21 selects options one by one from the individual parameters identified by the parameter data 11, identifies a plurality of analysis methods, and generates the analysis method data 12. In the case of the parameter data illustrated in FIG. 2, of the seven types of parameters, there are five types of parameters with two options and two types of parameters with three options. The generation unit 21 identifies 288 analysis methods by 2×2×2×2×2×3×3 as the analysis method data 12.

The calculation unit 22 calculates the deviation degrees of two items of time-series data among the plurality of items of time-series data through the plurality of respective analysis methods. The deviation degree is an index of dissimilarity between the two items of time-series data. In the embodiment of the present invention, the deviation degree is calculated with a value between 0 and 1. The deviation degree may be calculated as any value and then may be normalized to a value between 0 and 1. In a case where the time-series data group 13 includes 100 types of time-series data, the number of combinations of two items of time-series data is 100×99/2=4950. In a case where the number of analysis methods is 288, the calculation unit 22 calculates the deviation degrees for the 4950 combinations through the 288 analysis methods.

When the deviation degrees are calculated through the plurality of respective analysis methods for the combinations of two time-series data, the calculation unit 22 calculates evaluation values of variations in the deviation degrees calculated through the plurality of respective analysis methods for the combinations. The calculation unit 22 calculates the evaluation values for the respective combinations of two items of time-series data among the plurality of items of time-series data. The calculation unit 22 stores the calculated evaluation values in the evaluation value data 15. In the case where the number of combinations of the two items of time-series data is 4950, the calculation unit 22 calculates 4950 evaluation values.

In the embodiment of the present invention, the evaluation value is calculated to have a positive correlation with proximity between the individual deviation degrees calculated through the plurality of respective analysis methods and an intermediate value and have a positive correlation with a variance of the individual deviation degrees. Here, the intermediate value is an intermediate value between the minimum value and the maximum value of the deviation degree that can be calculated through the analysis method. In the embodiment of the present invention, since the deviation degree is calculated between 0 and 1, the intermediate value is 0.5. The evaluation value is calculated by, for example, Equation (1).

$$[ Math . 1 ]$$

$$Evaluation value = {Proximity}^{m} between deviation degrees and intermediate value \times {Variance}^{n}$$

$$Proximity between deviation degrees and intermediate value = 0.5 - \vert ( 0.5 - \frac{{\sum }_{i = 1}^{N} Deviation {degree}_{i}}{N} ) \vert$$

$$Variance = \frac{{\sum }_{i = 1}^{N} Deviation {degree}_{i}^{2}}{N} - {\{ {\sum }_{i = 1}^{N} \frac{Deviation {degree}_{i}}{N} \}}^{2}$$

$$Deviation {degree}_{i} : Deviation degree calculated through analysis method i ( 0. - 1. ) \qquad Equation ( 1 )$$

$$N : Number of analysis methods$$

$$m , n : Weight ( numerical number of 0 or larger )$$

When the deviation degree is close to 0, this indicates that there is no deviation, that is, two items of time-series data are similar, and when the deviation degree is close to 1, this indicates that there is a deviation, that is, two items of time-series data are not similar. Hence, when the deviation degree is close to the intermediate value, this indicates that it is difficult to determine the similarity between two items of time-series data. In addition, a large value of the variance indicates that deviation degrees calculated by individual analysis methods vary, and it is difficult to determine the similarity between two items of time-series data.

The extraction unit 23 extracts combinations of two items of time-series data in which the evaluation values satisfy a predetermined condition. The extraction unit 23 extracts combinations of two items of time-series data having a relatively high evaluation value. Here, a relatively high evaluation value means an evaluation value higher than other evaluation values. The extraction unit 23 may extract combinations having evaluation values equal to or larger than a predetermined threshold value or may extract a predetermined number of combinations in descending order of the evaluation values. The extraction unit 23 generates the extraction data 16 that identifies the extracted combinations.

In some cases, an evaluator determines that it is possible to discriminate between presence or absence of a deviation between two items of time-series data among the combinations extracted by the extraction unit 23. Therefore, the update unit 24 displays the two items of time-series data of combinations extracted by the extraction unit 23 side by side. The update unit 24 allows the evaluator who has observed two items of time-series data of the combinations extracted by the extraction unit 23 to select a combination determined to enable the presence or absence of the deviation between the two items of time-series data to be discriminated. For the combination selected by the evaluator, the update unit 24 excludes an option that is a factor for calculating a high evaluation value.

Of the options, the update unit 24 excludes an option used in an analysis method in which the deviation degree is calculated to be relatively high for a combination determined to have no deviation by the evaluator. Here, the relatively high deviation degree means that the deviation degree is higher than other deviation degrees of the plurality of deviation degrees calculated by the individual analysis methods for the combination determined to have no deviation by the evaluator. The update unit 24 may identify, as an analysis method for calculating a relatively high deviation degree, an analysis method in which a deviation degree higher than a threshold value compared with a predetermined threshold is calculated. The update unit 24 may identify, as an analysis method for calculating a relatively high deviation degree, an analysis method in which a predetermined number of deviation degrees are calculated in descending order of the deviation degrees. The update unit 24 excludes, as options that are factors for calculating a high evaluation value, options used in the analysis method for calculating a relatively high deviation degree from the deviation degrees calculated for the combinations determined to have no deviation by the evaluator.

The update unit 24 excludes, of the options, an option used in the analysis method in which the deviation degree is calculated to be relatively low for the combination determined to have a deviation by the evaluator. Here, the relatively low deviation degree means that the deviation degree is lower than other deviation degrees of the plurality of deviation degrees calculated through the individual analysis methods for the combinations determined to have a deviation by the evaluator. The update unit 24 may identify, as an analysis method for calculating a relatively low deviation degree, an analysis method in which a deviation degree lower than a threshold value compared with the predetermined threshold is calculated. The update unit 24 may identify, as an analysis method for calculating a relatively low deviation degree, an analysis method in which a predetermined number of deviation degrees are calculated in ascending order of the deviation degrees. The update unit 24 excludes, as options that are factors for calculating a high evaluation value, options used in the analysis method for calculating a relatively low deviation degree from the deviation degrees calculated for the combinations determined to have a deviation by the evaluator.

The update unit 24 may exclude all of the options used in the analysis method for calculating a relatively high deviation degree for the combinations determined to have no deviation by the evaluator and the options used in the analysis method for calculating a relatively low deviation degree for the combinations determined to have a deviation by the evaluator or may exclude only some of the options. Regarding a predetermined number or more of the combinations, for example, the update unit 24 may exclude an option that is a factor for calculating a high evaluation value. In addition, the update unit 24 may allow the evaluator to evaluate the combinations of two items of time-series data in which evaluation values thereof satisfies the predetermined condition, which are extracted by the extraction unit 23, or may allow the evaluator to evaluate some of the combinations.

When the update unit 24 excludes the option, the calculation unit 22 calculates new evaluation values from deviation degrees calculated through a plurality of respective new analysis methods in which any one of the options after exclusion is selected for a combination of two items of time-series data among the plurality of items of time-series data. The calculation unit 22 calculates new evaluation values for respective combinations of two items of time-series data among the plurality of items of time-series data by using individual deviation degrees calculated through respective analysis methods in which any one of the options after exclusion is selected among the deviation degrees calculated by respective analysis methods in which that any one of the options before exclusion is selected. The extraction unit 23 extracts combinations of two items of time-series data in which the new evaluation values satisfy a predetermined condition. The extraction unit 23 generates the extraction data 16 that identifies the extracted combinations.

The exclusion of the options by the update unit 24 may be repeated a plurality of times. For example, the update unit 24 may repeat the exclusion of options or may repeat the exclusion of options a predetermined number of times until the evaluator who has observed the two items of time-series data of the combinations extracted by the extraction unit 23 determines that the presence or absence of the deviation between the two items of time-series data cannot be discriminated for any combination.

The output unit 25 outputs the combinations extracted by the extraction unit 23. The output unit 25 outputs the extraction data 16 as data that is difficult for a data scientist to determine. In a case where the evaluator who has observed the two items of time-series data of the combinations extracted by the extraction unit 23 determines that the presence or absence of the deviation between the two items of time-series data cannot be discriminated, the output unit 25 may output the extraction data 16 as data that is difficult for the data scientist to determine.

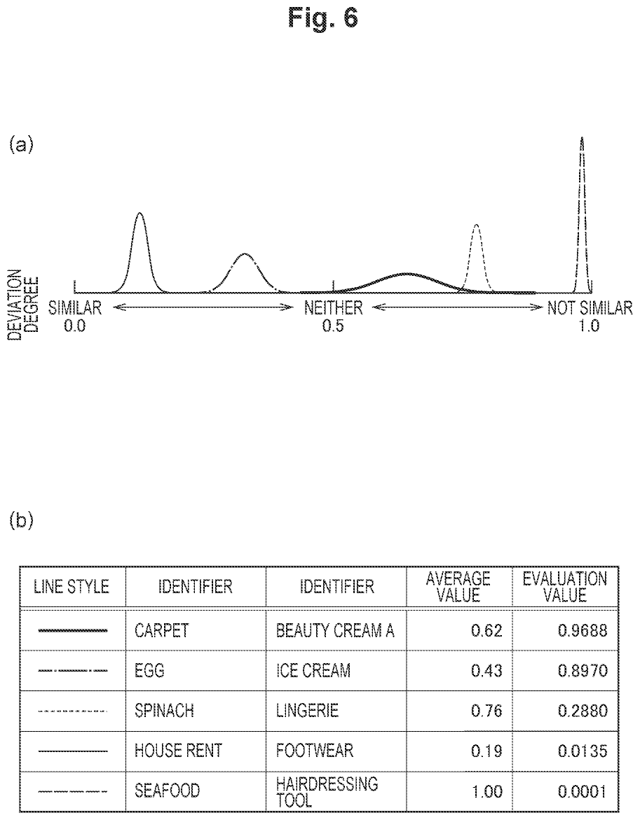

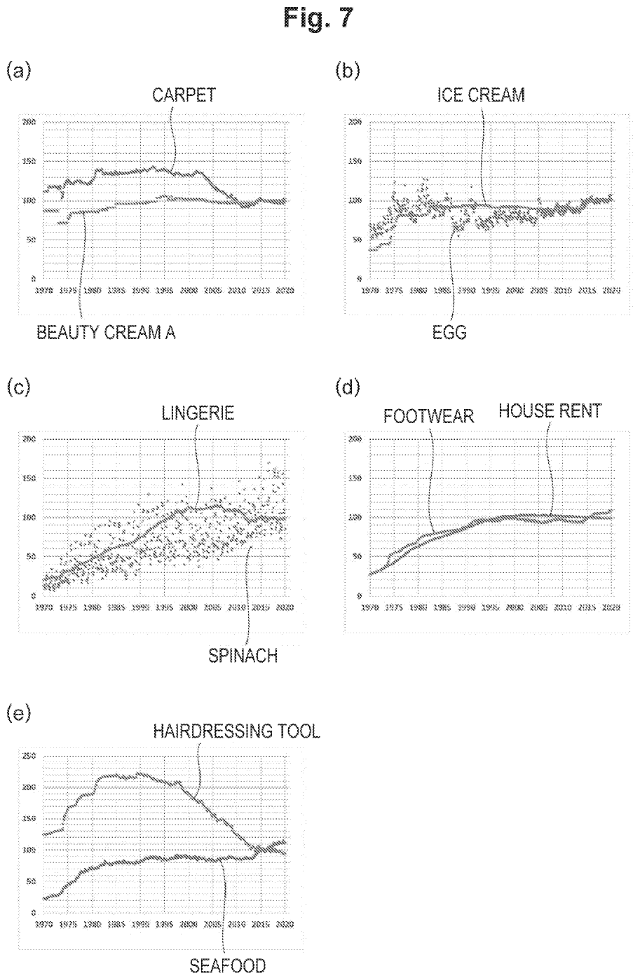

An evaluation value according to the embodiment of the present invention will be described with reference to FIGS. 6 and 7. In FIGS. 6 and 7, five combinations of two items of time-series data will be described. The deviation degree and the evaluation value illustrated in FIG. 6 are calculated for each combination of time-series data illustrated in FIG. 7. FIG. 6(a) illustrates a distribution of deviation degrees calculated by individual analysis methods for individual combinations. FIG. 6(b) illustrates an average and an evaluation value of deviation degrees calculated by the individual analysis methods for the individual combinations.

As illustrated in FIG. 6(a), it is apparent that a combination having a deviation degree close to 0, specifically, a combination of “house rent” and “footwear”, is similar as illustrated in FIG. 7(d). It is apparent that a combination having a deviation degree close to 1, specifically, a combination of “seafood” and “hairdressing tool”, is dissimilar as illustrated in FIG. 7(e). As described above, a combination having a deviation degree close to 0 or 1 is clearly similar or dissimilar, and thus the evaluation value is calculated to be low. Hence, the combination is not extracted as the extraction data 16.

On the other hand, a combination having a deviation degree close to 0.5 is calculated to have a high evaluation value and is likely to be extracted as the extraction data 16. For example, as the combination having the deviation degree close to 0.5, there are a combination of “carpet” and “beauty cream A” and a combination of “egg” and “ice cream”. As illustrated in FIG. 6(a), the combination of “carpet” and “beauty cream A” has a larger variance of deviation degrees than the combination of “egg” and “ice cream”, and thus the evaluation value is calculated to be large.

In the embodiment of the present invention, in a case where a result as illustrated in FIG. 6 is obtained and two combinations are extracted as the extraction data 16, the processing device 1 extracts the combination of “carpet” and “beauty cream A” and the combination of “egg” and “ice cream” in descending order of the evaluation values. For the time-series data of “carpet” and “beauty cream A”, it is difficult to discriminate between similarity and dissimilarity as illustrated in FIG. 7(a). In addition, for the time-series data of “egg” and “ice cream”, it is difficult to discriminate between similarity and dissimilarity as illustrated in FIG. 7(b). Hence, the evaluation value calculated by the processing device 1 can be an index for determination of similarity or dissimilarity of the time-series data.

### (Processing Method)

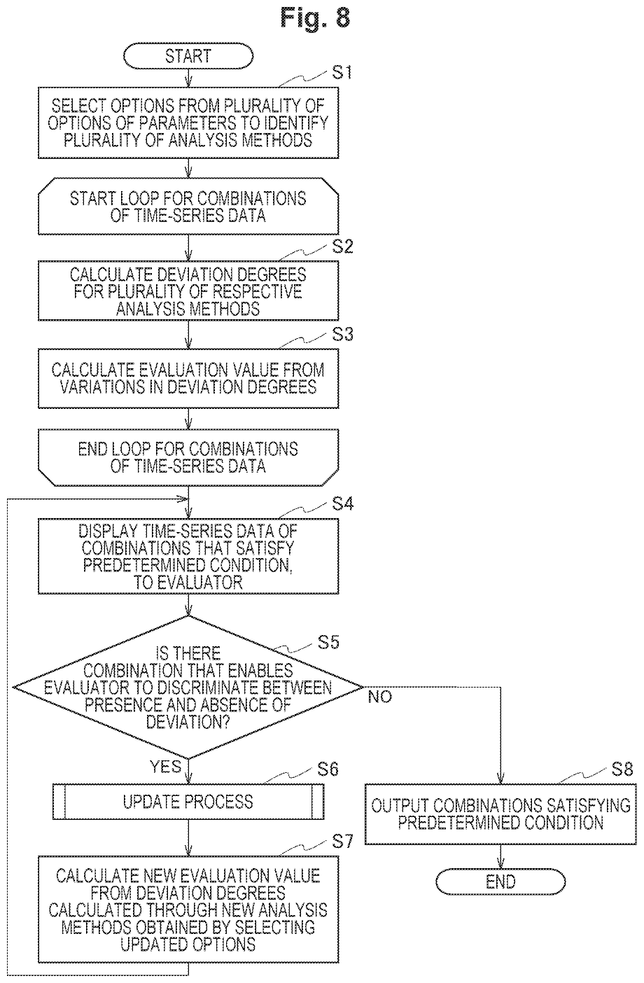

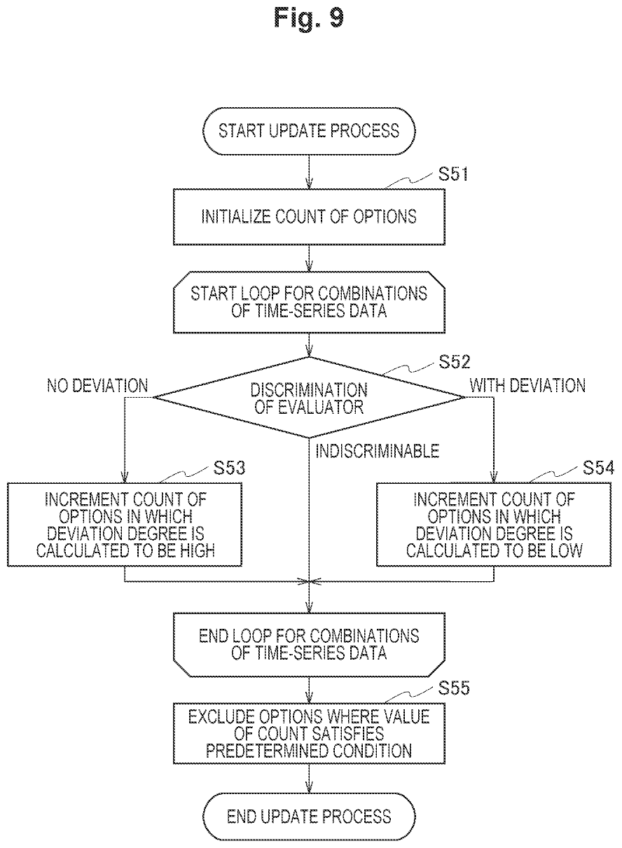

A process performed by the processing device 1 according to the embodiment of the present invention is described with reference to FIGS. 8 and 9.

In Step S1, the processing device 1 selects options from a plurality of options for a parameter used in an analysis method and identifies a plurality of analysis methods.

The processing device 1 processes Steps S2 and S3 for any combinations of two items of time-series data in the time-series data group 13. In Step S2, the processing device 1 calculates a plurality of deviation degrees by using the plurality of respective analysis methods identified in Step S1 for two items of time-series data of the combinations that are processing targets. In Step S3, the processing device 1 calculates evaluation values from variations in the plurality of deviation degrees calculated in Step S2.

When the evaluation values are calculated for the individual combinations, the process proceeds to Step S4. In Step S4, the processing device 1 displays the time-series data of a combination satisfying the predetermined condition to the evaluator. For example, the processing device 1 displays time-series data of a combination having a relatively high evaluation value, such as a combination having an evaluation value equal to or larger than a threshold value and a predetermined number of combinations in descending order of the evaluation values.

In Step S5, the processing device 1 distributes the process according to whether or not there is a combination for which the evaluator can discriminate between presence and absence of the deviation of the combinations of time-series data displayed in Step S4. In a case where there is a combination for which the evaluator can discriminate between presence and absence of the deviation, the update processing is performed in Step S6. In the update processing, an option that causes calculation of the high evaluation value are excluded.

In Step S7, the processing device 1 calculates new evaluation values from deviation degrees to be calculated by new analysis methods obtained by selecting options after the exclusion is performed by the update processing. Here, the processing device 1 identifies a deviation degree calculated by an analysis method other than the analysis method using the option excluded by the update processing, of the deviation degrees calculated in Step S2, and calculates an evaluation value from the identified deviation degree. A new evaluation value is calculated for each combination of the time-series data.

When the new evaluation value is calculated, in Step S4, the processing device 1 displays the time-series data of the combination satisfying the predetermined condition to the evaluator and enables the evaluator to input again whether or not there is a combination for which discrimination between presence and absence of a deviation can be performed. In a case where there is a combination for which the evaluator can discriminate between presence and absence of the deviation, Steps S7 and S8 are processed, and the process returns to Step S4. In a case where there is no combination for which the evaluator can discriminate between presence and absence of the deviation, of the combinations of the time-series data displayed in Step S4, the process proceeds to Step S8. In Step S8, the processing device 1 outputs a combination having a relatively high evaluation value as data that is difficult for a data scientist to determine.

The update processing will be described with reference to FIG. 9. First, in Step S51, the processing device 1 initializes a count for each option.

Steps S52 to S54 are processed for each combination of the time-series data. In Step S52, the processing device 1 distributes the process depending on discrimination of the evaluator for the combinations of processing targets. In a case where the evaluator determines that there is no deviation for the combination of the processing targets, the process proceeds to Step 353. In Step S53, the processing device 1 increments a count of options used in the analysis method in which the high deviation degree is calculated. In a case where the evaluator determines that there is a deviation in the combination of the processing targets, the process proceeds to Step S54. In Step S54, the processing device 1 increments a count of options used in the analysis method in which the low deviation degree is calculated. When the evaluator cannot make a determination for the combination of the processing targets, the count of options is not changed.

When the processing from Step S52 to Step S54 ends for each combination of time-series data, the process proceeds to Step S55. In Step 355, the processing device 1 excludes options in which a value of the count satisfies a predetermined condition, specifically, the value of the count is higher than a predetermined threshold value, a predetermined number of options in descending order of values of counts, or the like.

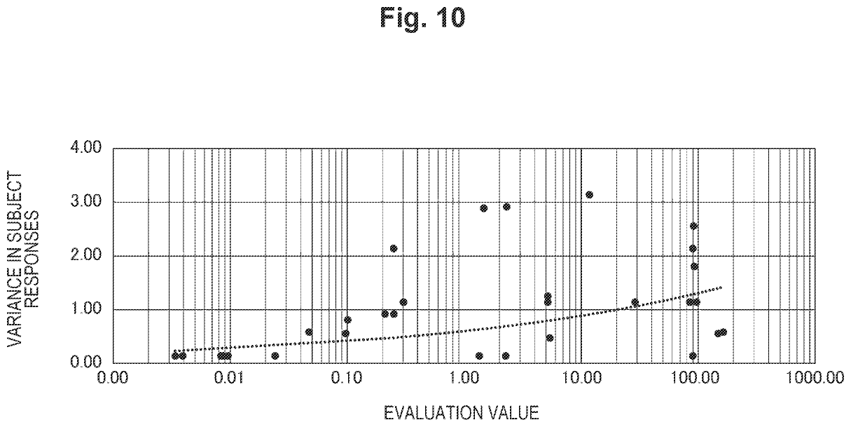

Next, with reference to FIG. 10, the evaluation value calculated by the processing device 1 is compared with a determination of similarity or dissimilarity made by a subject. The evaluation value calculated by the processing device 1 is divided into five levels, six combinations of two items of time-series data are extracted from each stage, and a total of 30 combinations of time-series data are displayed for one subject. The subject evaluates similarity or dissimilarity of the two displayed items of time-series data for each combination. The subject makes an evaluation as one point in a case where the two items of time-series data are similar and seven points in a case where the two items of time-series data are not similar and makes the evaluation in seven levels depending on a degree of similarity or dissimilarity.

FIG. 10 illustrates, for a certain set of time-series data, an evaluation value calculated by the processing device 1 and a variance of evaluations made by six subjects in association with each other. The vertical axis in FIG. 10 represents the variance of the evaluations made by six subjects for one combination of time-series data. The horizontal axis represents the evaluation value calculated by the processing device 1. A scale of the evaluation value on the horizontal axis is changed to be about 0 to 100, assuming that both weights m and n in Equation (1) are 2.

As illustrated in FIG. 10, it can be found that a variance in answers of the subject increases as the evaluation value increases. As a result, it can be found that the evaluation value calculated by the processing device 1 indicates difficulty in determining similarity or dissimilarity between the two items of time-series data.

As described above, the processing device 1 according to the embodiment of the present invention can calculate the evaluation value indicating the difficulty in determining similarity or dissimilarity between the two items of time-series data. The processing device 1 can support efficient data analysis to be performed by a data scientist by extracting a combination of time-series data that is difficult for the data scientist to determine from a large amount of data on the basis of the evaluation value.

As the processing device 1 of the present embodiment described above, for example, a general-purpose computer system including the central processing unit (CPU, processor) 901, the memory 902, the storage 903 (hard disk drive (HDD), solid state drive (SSD)), a communication device 904, an input device 905, and an output device 906 is used. In the computer system, each function of the processing device 1 is implemented by the CPU 901 executing a program loaded on the memory 902.

Note that the processing device 1 may be implemented by one computer or may be implemented by a plurality of computers. In addition, the processing device 1 may be a virtual machine that is implemented in a computer.

The program of the processing device 1 can be stored in a computer-readable recording medium such as an HDD, an SSD, a universal serial bus (USB) memory, a compact disc (CD), or a digital versatile disc (DVD), or can be distributed via a network.

Note that the present invention is not limited to the above embodiment, and various modifications can be made within the scope of the gist of the present invention.

### REFERENCE SIGNS LIST

1 Processing device
11 Parameter data
12 Analysis method data
13 Time-series data group
14 Deviation degree data
15 Evaluation value data
16 Extraction data
21 Generation unit
22 Calculation unit
23 Extraction unit
24 Update unit
25 Output unit
901 CPU
902 Memory
903 Storage
904 Communication device
905 Input device
906 Output device

1. A processing device comprising:
a calculation unit, including one or more processors, configured to calculate deviation degrees of two items of time-series data among a plurality of items of time-series data through a plurality of respective analysis methods and calculates an evaluation value of variations in the deviation degrees calculated through the plurality of respective analysis methods for combinations of two items of time-series data among the plurality of items of time-series data;
an extraction unit including one or more processors, configured to extract combinations of two items of time-series data for which the evaluation value satisfies a predetermined condition; and
an output unit including one or more processors, configured to output the extracted combination.

2. The processing device according to claim 1, further comprising: a generation unit including one or more processors, configured to generate, as the plurality of analysis methods, analysis methods in which any one of options of parameters for calculating a deviation degree of two items of time-series data is selected.

3. The processing device according to claim 2, further comprising: an update unit, including one or more processors, configured to allow an evaluator who has observed the two items of time-series data of the combinations extracted by the extraction unit to select a combination determined to enable presence and absence of a deviation between the two items of time-series data to be discriminated and that excludes an option used in an analysis method in which the deviation degree is calculated to be relatively high for the combination determined by the evaluator to have no deviation and an option used in an analysis method in which the deviation degree is calculated to be relatively low for the combination determined by the evaluator to have a deviation, from options, wherein
the calculation unit is configured to calculate a new evaluation value from deviation degrees calculated through a plurality of respective new analysis methods in which any one of the options after exclusion is selected for a combination of two items of time-series data among the plurality of items of time-series data, and
the extraction unit is configured to extract combinations of two items of time-series data in which the new evaluation value satisfies a predetermined condition.

4. The processing device according to claim 1, wherein the output unit is configured to output the combination extracted by the extraction unit in a case where the evaluator who has observed the two items of time-series data of the combinations extracted by the extraction unit determines that presence or absence of a deviation between the two items of time-series data is not discriminable.

5. The processing device according to claim 1, wherein the evaluation value has a positive correlation with proximity between deviation degrees calculated through the plurality of respective analysis methods and an intermediate value and has a positive correlation with a variance of the deviation degrees.

6. The processing device according to claim 1, wherein the evaluation value is calculated by:
$$Evaluation value = {Proximity}^{m} between deviation degrees and intermediate value \times {Variance}^{n}$$
$$Proximity between deviation degrees and intermediate value = 0.5 - \vert ( 0.5 - \frac{{\sum }_{i = 1}^{N} Deviation {degree}_{i}}{N} ) \vert$$
$$Variance = \frac{{\sum }_{i = 1}^{N} Deviation {degree}_{i}^{2}}{N} - {\{ {\sum }_{i = 1}^{N} \frac{Deviation {degree}_{i}}{N} \}}^{2} .$$
where Deviation degree, represents a deviation degree calculated through analysis method i (0.0-1.0),
N represents a number of analysis methods, and
m and n represent weights (numerical numbers of 0 or larger).

7. A processing method comprising:
calculating, by a computer, deviation degrees of two items of time-series data among a plurality of items of time-series data through a plurality of respective analysis methods;
calculating, by the computer, an evaluation value of variations in deviation degrees calculated through the plurality of respective analysis methods for combinations of two items of time-series data among the plurality of items of time-series data;
extracting, by the computer, combinations of two items of time-series data for which the evaluation value satisfies a predetermined condition; and
outputting, by the computer, the extracted combinations.

8. A non-transitory computer-readable storage medium storing program for causing a computer to perform operations comprising:
calculating deviation degrees of two items of time-series data among a plurality of items of time-series data through a plurality of respective analysis methods;
calculating an evaluation value of variations in deviation degrees calculated through the plurality of respective analysis methods for combinations of two items of time-series data among the plurality of items of time-series data;
extracting combinations of two items of time-series data for which the evaluation value satisfies a predetermined condition; and
outputting the extracted combinations.

9. The processing method according to claim 7, further comprising:
generating, as the plurality of analysis methods, analysis methods in which any one of options of parameters for calculating a deviation degree of two items of time-series data is selected.

10. The processing method according to claim 9, further comprising:
allowing an evaluator who has observed the two items of time-series data of the combinations to select a combination determined to enable presence and absence of a deviation between the two items of time-series data to be discriminated and that excludes an option used in an analysis method in which the deviation degree is calculated to be relatively high for the combination determined by the evaluator to have no deviation and an option used in an analysis method in which the deviation degree is calculated to be relatively low for the combination determined by the evaluator to have a deviation, from options;
calculating a new evaluation value from deviation degrees calculated through a plurality of respective new analysis methods in which any one of the options after exclusion is selected for a combination of two items of time-series data among the plurality of items of time-series data; and
extracting combinations of two items of time-series data in which the new evaluation value satisfies a predetermined condition.

11. The processing method according to claim 7, further comprising:
outputting the combination in a case where the evaluator who has observed the two items of time-series data of the combinations determines that presence or absence of a deviation between the two items of time-series data is not discriminable.

12. The processing method according to claim 7, wherein the evaluation value has a positive correlation with proximity between deviation degrees calculated through the plurality of respective analysis methods and an intermediate value and has a positive correlation with a variance of the deviation degrees.

13. The non-transitory computer-readable storage medium according to claim 8, wherein the operations further comprise:
generating, as the plurality of analysis methods, analysis methods in which any one of options of parameters for calculating a deviation degree of two items of time-series data is selected.

14. The non-transitory computer-readable storage medium according to claim 13, wherein the operations further comprise:
allowing an evaluator who has observed the two items of time-series data of the combinations to select a combination determined to enable presence and absence of a deviation between the two items of time-series data to be discriminated and that excludes an option used in an analysis method in which the deviation degree is calculated to be relatively high for the combination determined by the evaluator to have no deviation and an option used in an analysis method in which the deviation degree is calculated to be relatively low for the combination determined by the evaluator to have a deviation, from options;
calculating a new evaluation value from deviation degrees calculated through a plurality of respective new analysis methods in which any one of the options after exclusion is selected for a combination of two items of time-series data among the plurality of items of time-series data; and
extracting combinations of two items of time-series data in which the new evaluation value satisfies a predetermined condition.

15. The non-transitory computer-readable storage medium according to claim 8, wherein the operations further comprise:
outputting the combination in a case where the evaluator who has observed the two items of time-series data of the combinations determines that presence or absence of a deviation between the two items of time-series data is not discriminable.

16. The non-transitory computer-readable storage medium according to claim 8, wherein the evaluation value has a positive correlation with proximity between deviation degrees calculated through the plurality of respective analysis methods and an intermediate value and has a positive correlation with a variance of the deviation degrees.
